(19) United States
(12) Patent Application Publication
(10) Pub. No.: US 2014/0298698 A1
(43) Pub. Date: Oct. 9, 2014

(54) DISPLAY DEVICE AND RAIL FOR HOLDING THE DEVICE

(71) Applicant: BRUEGMANN USA, INC., Houston, TX (US)

(72) Inventor: Malte Bruegmann, Houston, TX (US)

(73) Assignee: Bruegmann USA, Inc., Houston, TX (US)

(21) Appl. No.: 13/887,383

(22) Filed: May 6, 2013

Related U.S. Application Data
(63) Continuation of application No. 13/857,296, filed on Apr. 5, 2013.

(51) Int. Cl. G09F 7/18

(52) U.S. Cl. CPC G09F 7/18
USPC 40/606.01

(57) ABSTRACT

A product information display system includes a rail and at least one product information display. The rail has retainers on lateral ends thereof defining grooves for retaining the at least one product information display. The at least one product information display has a mounting tab disposed on one side thereof. The mounting tab has a short dimension selected to fit between the retainers, and a long dimension selected to provide friction fit between the grooves.

### CROSS-REFERENCE TO RELATED APPLICATIONS

This is a continuation in part of U.S. patent application Ser. No. 13/857,296 filed on Apr. 5, 2013, which application is incorporated herein by reference in its entirety.

### STATEMENT REGARDING FEDERALLY SPONSORED RESEARCH OR DEVELOPMENT

Not applicable.

### BACKGROUND

This disclosure relates generally to the field of retail product displays. More particularly the disclosure relates to information display tags for retail product displays and rails for movably securing the information display tag.

Retail product displays information tags to display information such as price and product quantity for retail product packages stored on retail shelf displays. The information tag, which may be a paper tag, plastic tag or electronic display, is typically affixed to a leading edge or front rail of the shelving. Affixing the information tag is typically performed by adhesive bonding, electrostatic attraction or using fasteners such as screws.

There is a need for an improved device for securing product information tags.

### SUMMARY

One aspect is a product information display system including a rail and at least one information display. The rail has retainers on lateral ends thereof defining grooves for retaining the at least one information display. The at least one information display has a mounting tab disposed on one side thereof. The mounting tab has a short dimension selected to fit between the retainers, and a long dimension selected to provide friction fit between the grooves.

Other aspects and advantages will be apparent from the description and claims which follow.

### BRIEF DESCRIPTION OF THE DRAWINGS

FIG. 1 is an oblique view of an example hanger rail and hook type product hangers secured thereto.

FIG. 2 is a side view of the hanger rail and hangers of FIG. 1.

FIG. 3 is an end view of an example hanger rail.

FIG. 4 is a view proximate a bottom end of the example hanger rail.

FIG. 5 is a view proximate an upper end of the example hanger rail.

FIG. 6 is an oblique front view of one of the hangers.

FIG. 7 is an oblique front view of one of the hangers.

FIG. 8 is a rear view of one of the hangers.

FIG. 9 shows inserting a hanger into a rail.

FIG. 10 shows securing the hanger in the rail at a selected position.

FIG. 11 shows an example of the rail being suspended at a selected distance from a shelf support using an adjustable length support arm.

FIG. 12 shows an example of an adjustable length support arm.

FIGS. 13 and 14 show examples of a hook at one end of the support arm.

FIG. 15 shows an example product information display attached to a rail affixed to the front of a product display shelf.

FIG. 15A shows the product information display completely assembled.

FIG. 16 shows a side view of the example product information display.

FIG. 17 shows a side view of the product information display transverse to the view of FIG. 16.

FIG. 18 shows a front view of installing the example product information display to the rail.

FIG. 19 shows a front view of the product information display after assembly to the rail.

### DETAILED DESCRIPTION

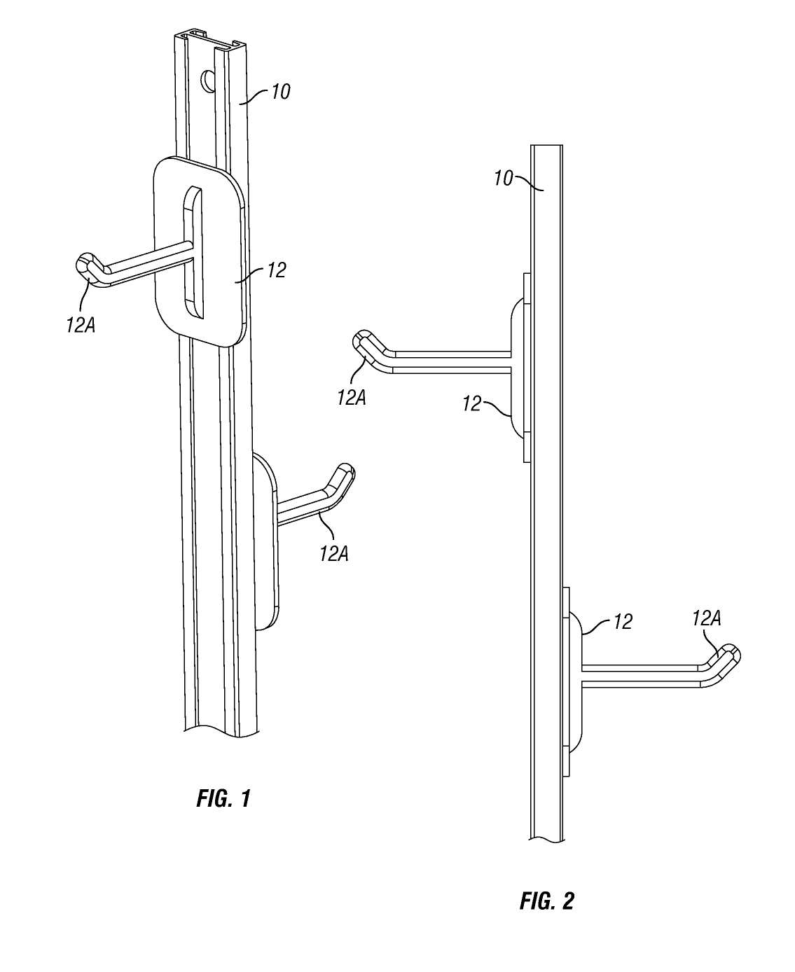

FIG. 1 shows an example hanger rail 10 including two hook type retail product hangers 12, one mounted on each side of the hanger rail 10. The hangers 12 may include a hook 12A of any selected length for holding retail product packaging. In the present example, hangers 12 may be mounted on each side of the rail 10. FIG. 2 shows the rail 10 and the hangers 12 in side view.

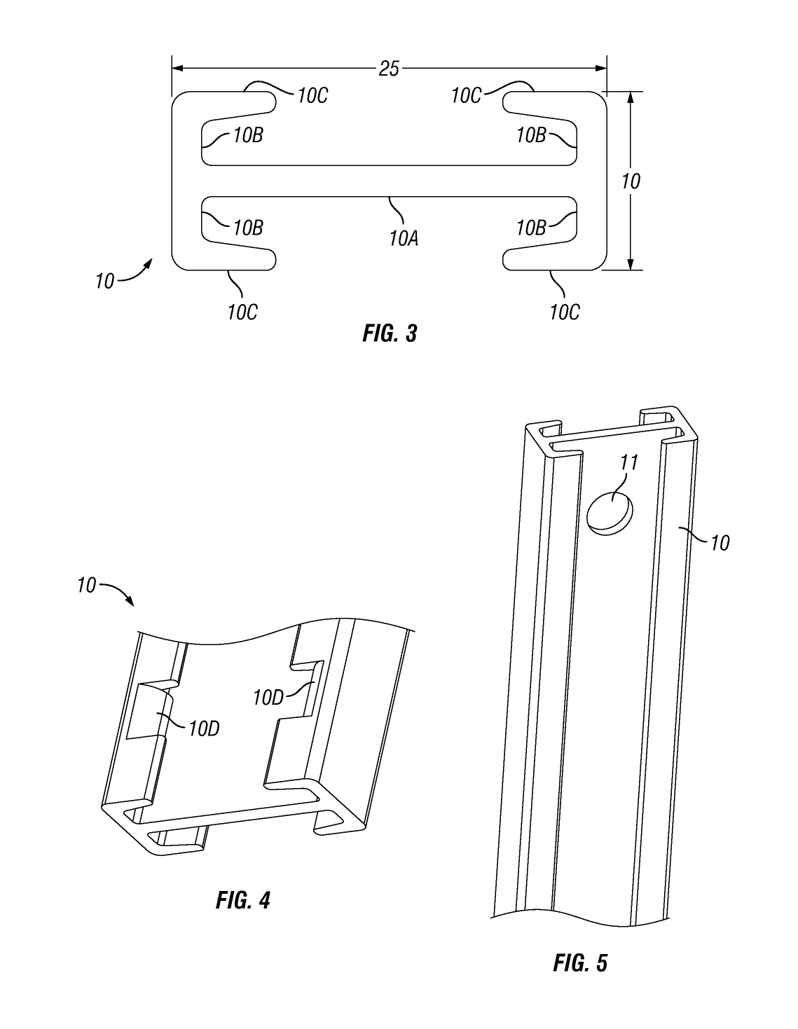

The example hanger rail 10 is shown in end view in FIG. 3 to illustrate some of the features thereof. The rail 10 may include a center bar 10A which supports spaced apart retainers 10C. The retainers 10C may be generally “C” shaped and define a groove 10B between the retainer 10C and the center bar 10A. The retainers 10C may be generally disposed at the lateral ends of the center bar 10A and on each side thereof so that the grooves 10B may be defined on both sides of the center bar 10A.

FIG. 4 shows a view proximate the bottom of the hanger rail 10, wherein the retainers (10C in FIG. 3) may be bent inwardly to create stops 10D. The stops 10D limit movement of the hangers (12 in FIG. 1) so that they cannot fall out of the bottom of the hanger rail 10.

An example hanger rail 10 shown in FIG. 5 may include an opening 11 for insertion of a hook or other device to suspend or mount the hanger rail 10 to a product display, shelf or other device. It is contemplated that the hanger rail 10 will be mounted so that both sides thereof will be accessible, such that retail product packaging may be accessed from both sides of the hanger rail 10.

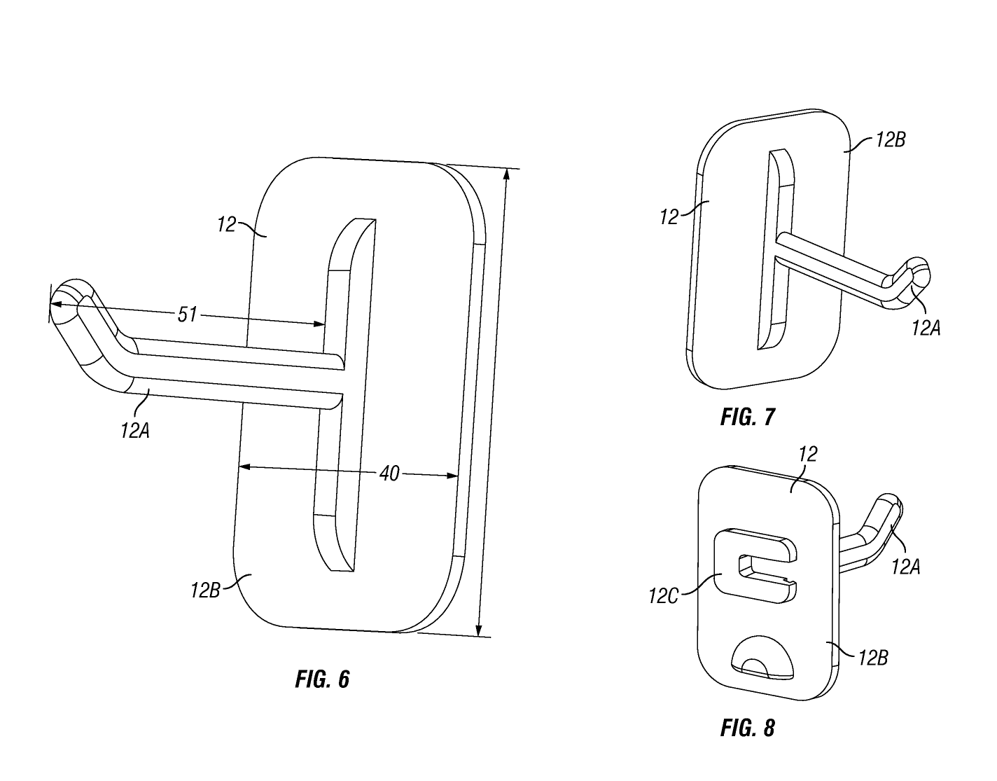

FIGS. 6 and 7 show oblique views of the front of one of the hangers 12. The hanger 12 may include a faceplate 12B that covers substantially the entire area of the hanger rail (10 in FIG. 4) when the hanger 12 is mounted to the hanger rail.

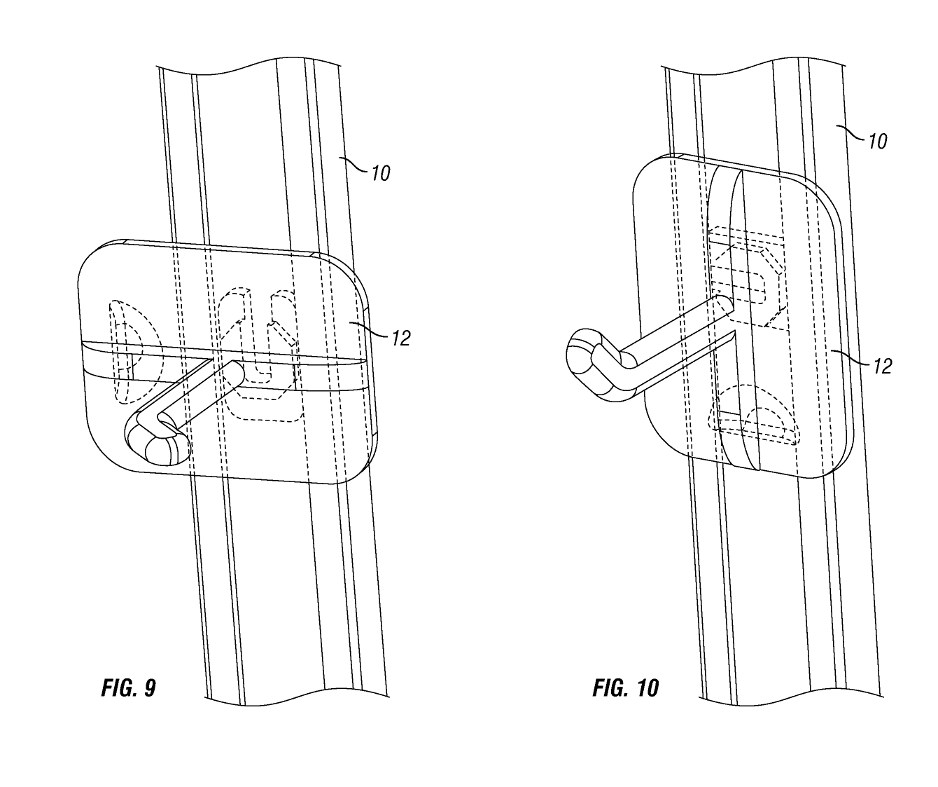

FIG. 8 shows a rear view of the example hanger 12. The rear face of the faceplate 12B may include a generally rectangular mounting tab 12C. The mounting tab 12C may be secured to the faceplate 12B at a short spacing, such as by a post or similar device (not shown). The hanger 12 as shown may be molded as a single unit from, for example, plastic, or may be assembled from separate components. The mounting tab 12C has a short dimension that enables free movement thereof into the space between the retainers (10C in FIG. 3) on the hanger rail, and a long dimension that enables a friction or interference fit between the mounting tab 12C and the grooves (10B in FIG. 3) in the hanger rail.

As shown in FIGS. 9 and 10, to mount a hanger 12 to the hanger rail 10, the hanger 12 is inserted into the hanger rail 10 between the retainers oriented transversely to its position in use. To lock the hanger 12 in position, the hanger may be rotated 90 degrees so that the long dimension of the mounting tab (12C in FIG. 8) is disposed across the hanger rail 10 and is friction or interference fit in the grooves (10B in FIG. 3).

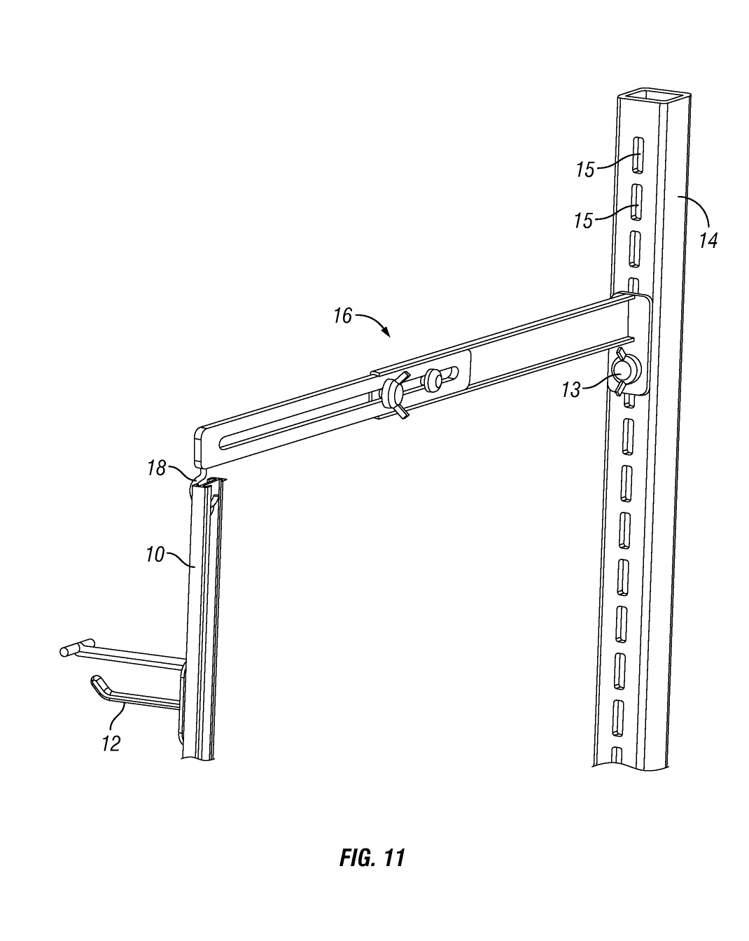

FIG. 11 shows an example of a hanger rail 10 as described with reference to FIGS. 3, 4 and 5 suspended a selected distance in front of a shelf support bracket 14. The shelf support bracket 14 may be of types known in the art that suspends supports using notched tabs on a back side thereof to engage slots 15 in the front face of the shelf support bracket 14. The support bracket 14 may be affixed to any structure in a manner well known in the art. In the present example, a support arm 16, such as an adjustable length arm may engage at one end thereof the shelf support bracket 14 at any selected vertical position corresponding to the position of selected ones of the slots 15. The support arm 16 may be further secured to the shelf support bracket 14 with a threaded fastener 13. The other end of the support arm 16 may have a hook 18 or similar device attached to or engaged therewith to suspend the hanger rail 10. An example hook 12 as explained above with reference to FIGS. 6-10 may be engaged to the hanger rail 10 at a selected axial position. Other examples may include more than one such hook as explained above.

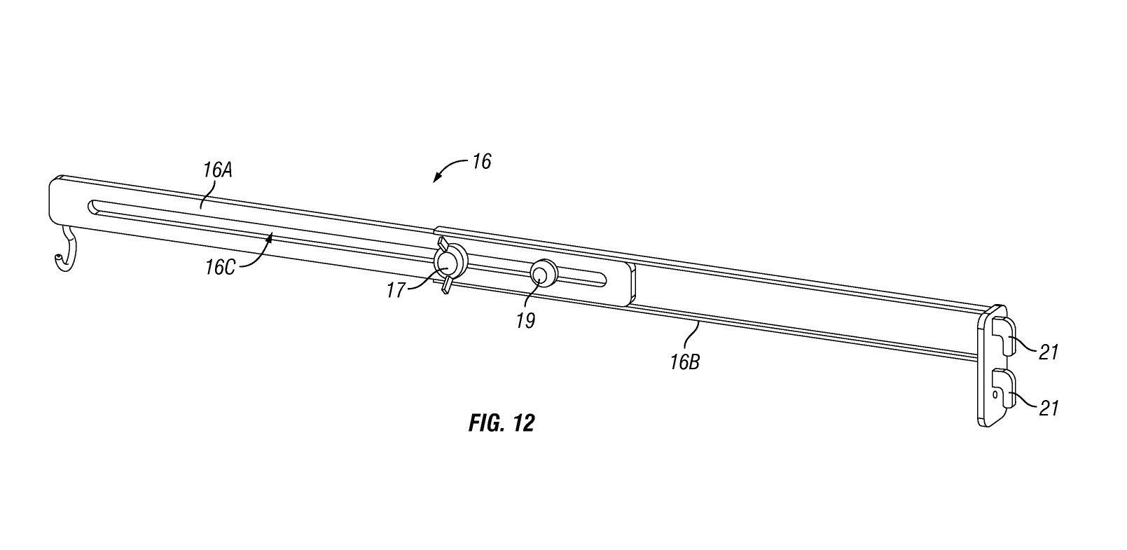

FIG. 12 shows an example of an adjustable length embodiment of the support arm 16. A first arm section 16A may include an elongated slot 16C to slidingly engage a pin or rivet 19 disposed proximate one end of a second arm section 16B. The second arm section 16B may include at its other end notched tabs 21 to engage selected ones of the slots (15 in FIG. 11) on the shelf support bracket (14 in FIG. 11). A screw and lock nut or wing nut 17 may also be disposed proximate the one end of the second arm section 16B. Tightening the lock nut or wing nut 17 will fix the position of the first arm section 16A with respect to the second arm section 16B, thus fixing the length of the adjustable length embodiment of the support arm 16. In other examples the support arm 16 may be fixed length.

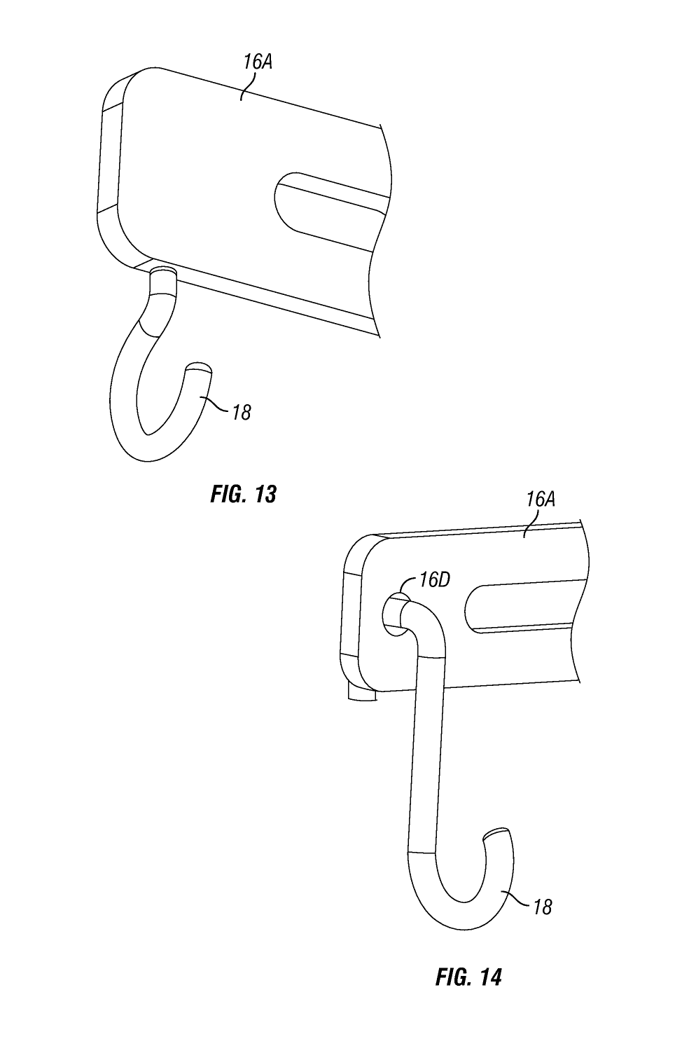

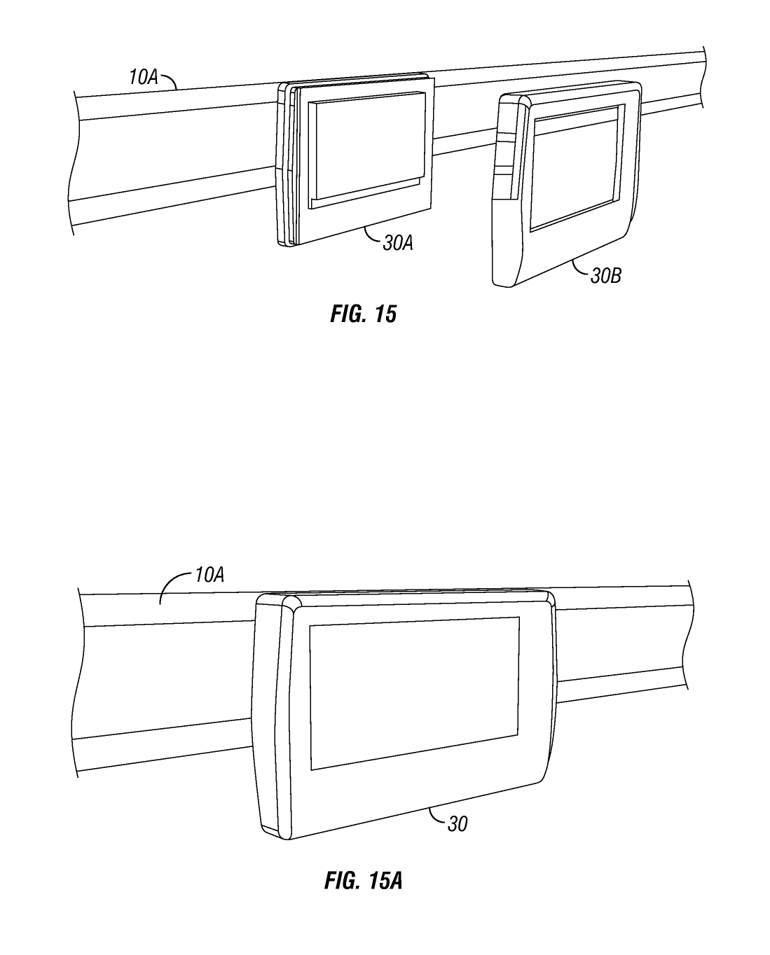

FIG. 13 shows a hook 18 affixed to the one end of the support arm, in the present example the support arm being an adjustable version including a first arm section 16A as explained with reference to FIG. 12. The hook 18 may be welded proximate the end of the first arm section 16A. FIG. 14 shows another example in which the hook 18 is configured to pass through an opening proximate the one end of the first arm section 16A. The hook 18 may suspend the hanger rail (10 in FIG. 11) as explained with reference to FIG. 11. The examples shown in FIGS. 13 and 14 are equally applicable to both fixed length and adjustable length support arms.

A hanger and rail combination as described herein may enable more dimensional choices in mounting of product hangers than hangers mounted in fixed positions.

In other examples, the faceplate (12B in FIG. 8) may be omitted entirely, and the hanger may include only the hook and mounting tab.

In another aspect, the same principle may be used to affix product information displays to a rail disposed on a product display shelf. By way of example, and without limitation, a rail similar to that shown in FIGS. 3, 4 and 5, but with retainers only on one side may be affixed to the front edge of a product display shelf system such as one sold under the trademark PROSHELF, which is a trademark of Bruegmann USA, Inc., Houston, Tex. As will be appreciated by those skilled in the art, such shelving systems may include a plurality of vertically stacked shelf systems each having its own front edge, and in some examples, a rail such as explained above may be affixed to any one or more of the front edges of such stacked shelf systems.

Referring to FIG. 15, an example product information display mechanism 30A may be affixed to a rail 10A made as explained above. The shelf system is omitted from FIGS. 15 through 19 only for clarity of the illustration. The example product display mechanism 30A shown in FIG. 15 may be an electronic programmable display, such as may include (none of which are shown separately) a liquid crystal display to display product information for the product on the particular shelf behind the display mechanism 30A such as price, product description and quantity in the product containers on such shelf. Such display mechanism 30A may be secured by a removable protective cover 30B to enable service of the display mechanism 30A while reducing damage during ordinary use. FIG. 15A shows the product information display 30 assembled to the rail 10A. Other examples of product display may include plain, flat faceplace surfaces on which adhesive labels or electrostatically affixed labels may be applied. Thus, the example shown in FIGS. 15 an 15A of the product information display should not be construed as limiting the scope of the present disclosure.

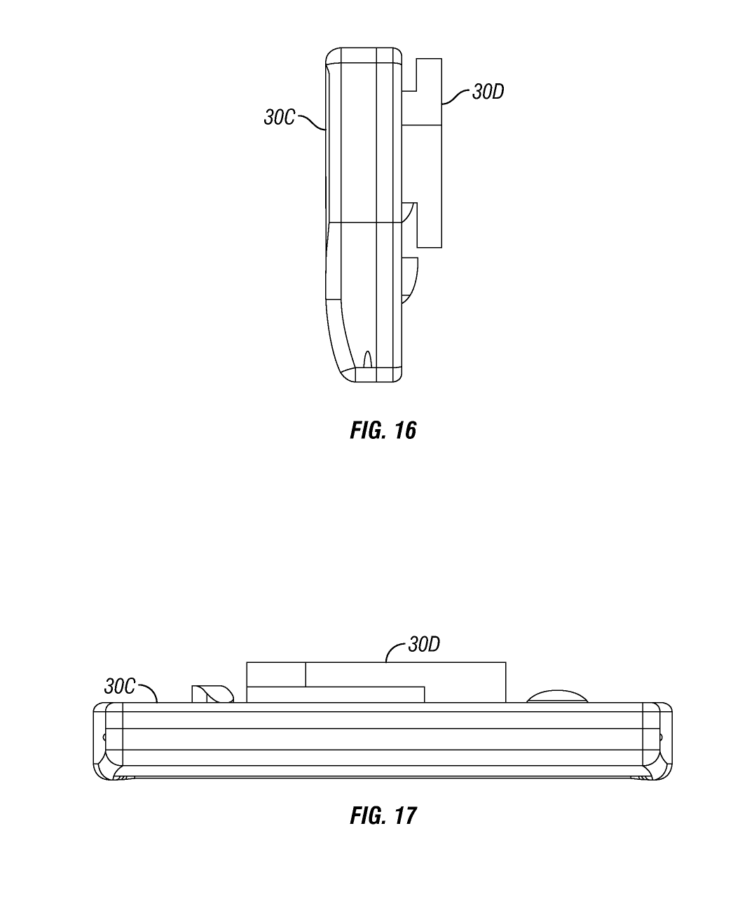

FIG. 16 shows a side view of the product information display. The faceplate is shown at 30C, and a mounting tab 30D may be affixed to or formed as part of the faceplate 30C. The mounting tab 30D may have dimensions and spacing from the back of the faceplate 30C selected substantially as explained above with reference to FIG. 8. A side view of the product information display rotated 90 degrees from the view in FIG. 16 is shown in FIG. 17.

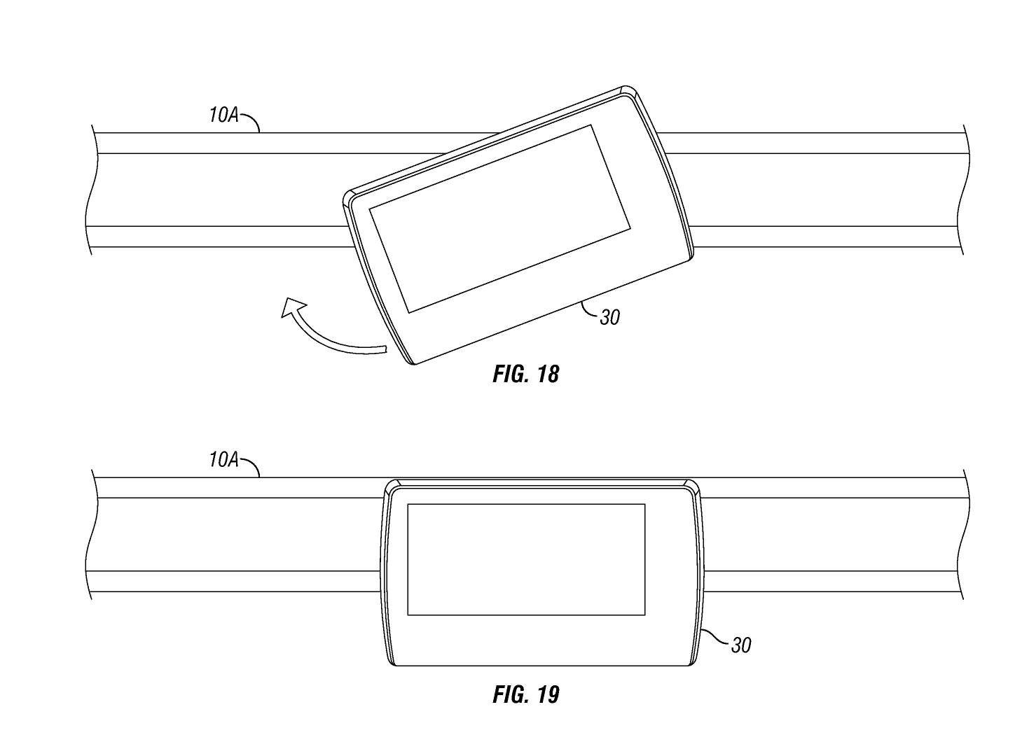

FIG. 18 shows insertion of the product information display 30 into the rail 10A by initially inserting the product information display at an angle. Thus, the product information display may be affixed to the rail substantially as explained with reference to the hangers explained with reference to FIGS. 1, 2 6, 7 and 8. After the mounting tab (30D in FIG. 17) into the space between the retainers on the rail (see FIG. 3), the product information display may be rotated so that the mounting tab (30D in FIG. 17) engages the retainers by friction fit. The product information display may be moved along the rail 10A or removed therefrom entirely by reversing the above described rotation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A product information display system, comprising:
a rail; and
at least two product information displays, the rail having retainers on lateral ends and on both sides thereof defining grooves for retaining the at least two product information displays, the at least two product information displays each having a mounting tab disposed on one side thereof, the mounting tab having a short dimension selected to fit between the retainers, the mounting tab having a long dimension selected to provide friction fit between and with the grooves and to increase a distance between the grooves so as to reduce the distance between the grooves on the opposed side of the rail.

2. The product information display system of claim 1 wherein the at least two product information displays comprise electronic displays.

3. The product information display system of claim 1 wherein the at least two product information displays comprise faceplates.

4. The product information display system of claim 3 wherein the faceplates have dimensions selected to substantially cover the retainers.

5. The product information display system of claim 1 wherein the rail is affixable to a forward end of a product display shelf.
